(19) United States
(12) Patent Application Publication
(10) Pub. No.: US 2004/0252713 A1
(43) Pub. Date: Dec. 16, 2004

(54) Channel status management system for multi-channel LIU

(76) Inventors: Roger Taylor, Austin, TX (US); Avery Topps, Austin, TX (US); Devendar Kanthala, Austin, TX (US); James Satterwhite, Austin, TX (US)

Correspondence Address: HOWISON & ARNOTT, L.L.P, P.O. BOX 741715, DALLAS, TX, 75374-1715, US

(21) Appl. No.: 10/462,213

(22) Filed: Jun. 13, 2003

(51) Int. Cl. H04J 3/16

(52) U.S. Cl. 370/437; 370/516

(57) ABSTRACT

Channel status management system for multi-channel LIU. A method for managing status information in a multi-channel Line Interface Unit (LIU) embodied in an integrated circuit and having a plurality of channels and operable to generate a plurality of status signals regarding the status of various associated parameters relating to the operation of the LIU The method includes the steps of first providing a plurality of channel registers in channel register space for each of the channels in the LIU, select ones of the registers designated for storing status information for the associated channel and wherein there can be a change of state of the status for any parameter associated with the operation of the associated channel. Upon the occurrence of a change of state (CoS) for any of the status information, a CoS indication is provided therefor. A channel status information system (CSM) is provided for monitoring for the occurrence of a CoS indication at any of the channels. The CSM makes available to an external controller such occurrence. When the external controller requests information regarding such occurrence of the CoS indication, the CSM makes available information about the status information that was associated with the CoS that provided the CoS indication.

### CROSS-REFERENCE TO RELATED APPLICATIONS

This application is co-pending with U.S. patent application Ser. No. ______ filed on even date herewith, entitled “MULTI-CHANNEL LINE INTERFACE UNIT WITH ON-CHIP CLOCK MANAGEMENT” (Atty. Dkt. No. CCDA-26,207).

### TECHNICAL FIELD OF THE INVENTION

The present invention pertains in general to Line Interface Units (LIU) and, more particularly, to a multi-channel LIU having the ability to drive a clock signal from a single reference clock input for separately controlling the clocking of transmit data through a given channel and receive data through the same channel

### BACKGROUND OF THE INVENTION

A Line Interface Unit (LIU) is utilized to receive data from a digital telecommunication line, which is typically an analog subscriber line associated with a switching office. The LIU includes analog and digital signal ports providing high speed communications with the switching office and includes the ability to receive analog information, recover the clock signal therefrom and then transmit digital data to the digital side of the LIU. Conversely, digital transmission data can be received along with the transmission clock, encoded and transmitted out in the analog domain. The LIU thus provides a transceiver capability, which transceiver capability must accommodate various line rates, such as those associated with T3, E3 and STS-1. For a single channel LIU that operates at a single frequency, a reference clock can typically be provided that will allow processing of data at that clock rate. However, for multiple channel LIUs, each channel would have to have a separate clock provided thereto for the purpose of generating on-chip timing frequencies for the operation thereof, which on-chip timing would be utilized to operate jitter attenuators to smooth the clocks and also provide sampling clocks for the data conversion circuits. This, of course, requires additional clock inputs to the chip.

For multiple channel LIUs, a number of channels are provided on a single integrated circuit (chip) with each having a transmit path and a receive path. Each of these paths has associated therewith analog and digital circuitry that must perform a large number of operations on data as it is being processed and transmitted or received. During this processing, there are a number of parameters associated therewith that are monitored and alarm signals generated if these monitored parameters do not meet certain conditions. This will cause an alarm event to occur and result in the status of that parameter. Once an alarm event or change of status event occurs, a bit in an internal register will be set that can be accessed by an external host microcontroller. However, if there are a large number of channels within a single chip and a large number of chips on a board, this means that the host microcontroller must service a large number of alarm conditions and review the associated registers. Even if the alarm conditions are serviced in response to an interrupt signal, an interrupt from a single chip requires the host microcontroller to examine all of the registers for all of the alarm conditions for each channel, since there is typically no way to determine from the interrupt which of the registers has the alarm bit stored therein, thus requiring the step of accessing all of the registers.

### SUMMARY OF THE INVENTION

The present invention disclosed and claimed herein, in one aspect thereof, comprises a method for managing status information in a multi-channel Line Interface Unit (LIU) embodied in an integrated circuit and having a plurality of channels and operable to generate a plurality of status signals regarding the status of various associated parameters relating to the operation of the LIU The method includes the steps of first providing a plurality of channel registers in channel register space for each of the channels in the LIU, select ones of the registers designated for storing status information for the associated channel and wherein there can be a change of state of the status for any parameter associated with the operation of the associated channel. Upon the occurrence of a change of state (CoS) for any of the status information, a CoS indication is provided therefor. A channel status information system (CSM) is provided for monitoring for the occurrence of a CoS indication at any of the channels. The CSM makes available to an external controller such occurrence. When the external controller requests information regarding such occurrence of the CoS indication, the CSM makes available information about the status information that was associated with the CoS that provided the CoS indication.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates an overall diagram of the Line Interface Unit (LIU);

FIG. 2 illustrates a diagrammatic view of the clock management system;

FIG. 3 illustrates a detailed block diagram of a single channel;

FIG. 4 illustrates a diagrammatic view of a clock management system for multiple channels and the transmit paths there through;

FIG. 5 illustrates a block diagram of the analog phase lock loop;

FIG. 6 illustrates a block diagram of the transmitter architecture for multiple channels;

FIG. 7 illustrates a block diagram of the jitter/attenuator;

FIG. 8 illustrates a detail of the phase detector for the jitter/attenuator;

FIGS. 8a, 8b and 8c illustrate block diagrams of variations of the loop filter for the jitter/attenuator;

FIG. 9 illustrates a block diagram of a linear model of the loop filter for the jitter/attenuator;

FIG. 10 illustrates a flow chart for the numerically controlled oscillator;

FIG. 11 illustrates a block diagram of the numerically controlled oscillator;

FIG. 12 illustrates a block diagram for the output clock circuitry;

FIG. 13 illustrates a block diagram of the circuit for generating the on-chip ADC sampling clock;

FIG. 14 illustrates a diagram of the line interface unit connected to an external host microcontroller;

FIG. 15 illustrates a diagrammatic view of the channel status management system and internal register; and

FIG. 16 illustrates a flowchart for the operation of a channel status management system.

### DETAILED DESCRIPTION OF THE INVENTION

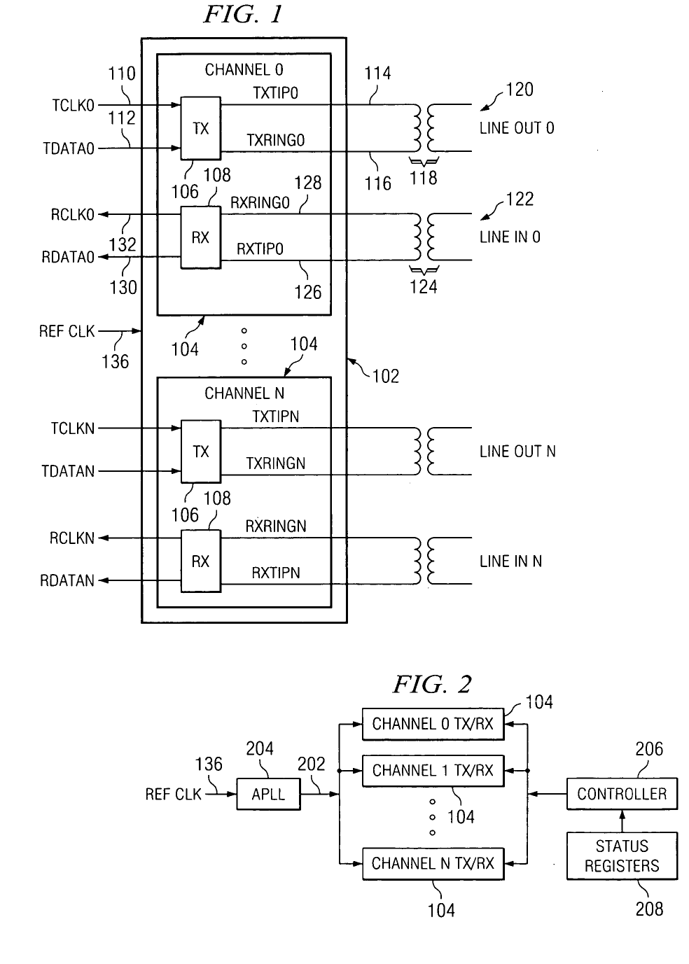

Referring now to FIG. 1, there is illustrated a diagrammatic view of a multi-channel LIU in accordance with the present disclosure. The multi-channel LIU is contained in a single integrated circuit 102. The integrated circuit 102 contains a plurality of transceiver channels 104 labeled channel 0 through channel N. Each of the channels 104 has contained therein a transmit section 106 and a receive section 108. The transmit section 106 is operable to receive digital data from a digital source, which provides a transmit clock on a transmit clock line 110 and transmit data on a transmit data line 112. The transmit section 106 is operable to convert the data on line 112 to analog data for output on two analog lines 114 and 116, which are input to an isolation transformer 118 on one side thereof to interface with an analog transmission line 120. The receive section 108, similarly, is operable to receive from an analog receive transmission line 122 via an isolation transformer 124 an analog transmission for input to the receive section 108 onto analog lines 126 and 128. The receive section 108 is operable to recover the clock signal from the data encoded in the analog transmission and convert this to digital data in the form of receive data on a line 130 and a recovered receive clock on a line 132. As will be described herein below, each of the channels 104 operates independently and can operate at different transmission rates. The timing is all facilitated with a single external reference clock received on a reference clock input 136.

Referring now to FIG. 2, there is illustrated a diagrammatic view of the LIU illustrating the channels 104 and the input reference clock signal on line 136 wherein the reference clock signal is utilized to generate an internal clock on a signal line 202 with the use of an analog phase lock loop (APLL) 204. Information from the clock signal 202 is input to each of the channels 104 for use therein, as will be described herein below. Additionally, an on-chip controller block 206 is provided for providing control information and processing information and capabilities to each of the channels 104. Various status information is contained within a status register 208. This will be described in more detail herein below.

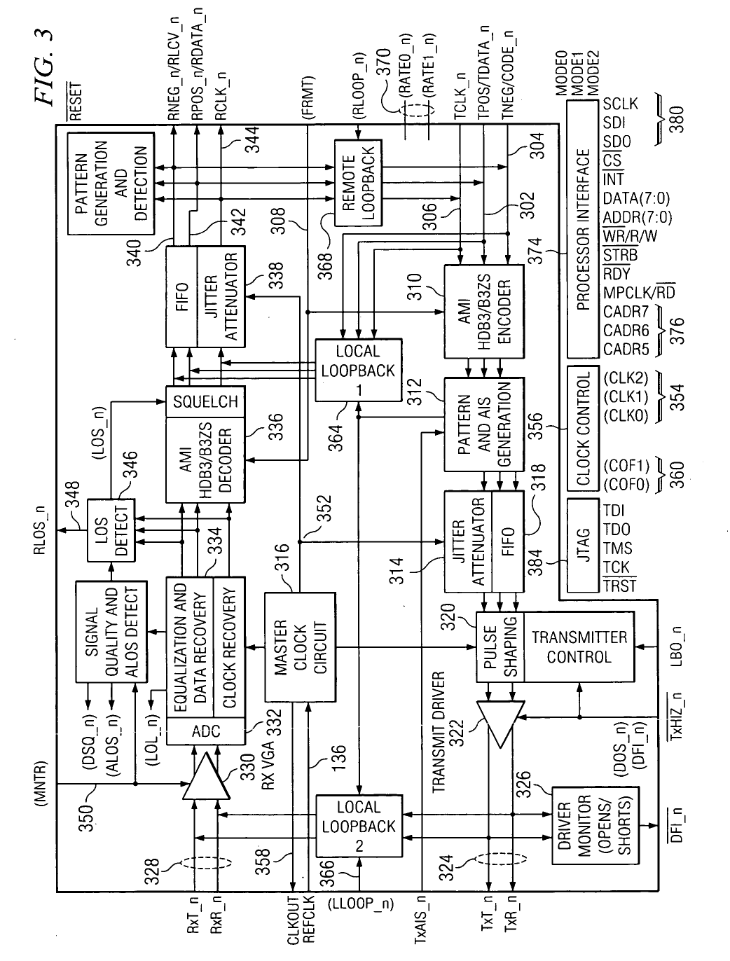

Referring now to FIG. 3, there is illustrated a block diagram of a single channel on the LIU. On the transmit side of the single channel, positive transmit data is received on a line 302 and negative transmit data is received on a line 304. The data to be transmitted is input in dual input mode on these two inputs and, alternatively, NRZ data can be input to the positive line 302 when the appropriate mode is selected. The data clock input is received on an input line 306. Data is sampled on the rising edge of the clock signal TCLK, it being noted that this can be changed through an internal register setting in a control register. The formatting of the data is determined by a signal on a Format input 308 which is operable to determine the encoding operation of an encoder 310, which encoder 310 has the inputs thereof connected to signal inputs 302, 304 and 306. The encoder 310 provides for AMI, HDB3 or B3ZS encoding, these being conventional. As will be described herein below, the TCLK signal provides timing synchronization for the transmit timing and this clock signal can be a “gapped” clock wherein there could be large gaps in the clock. The operation of the transmit path is controlled by a “clean” clock that is phase locked to the received transmit clock. This will be described in more detail herein below.

The output of the encoder 310 is input to a pattern generation block 312, the output thereof input to a jitter attenuator block 312 to essentially “reclock” the transmit data with a clean clock. Therefore, the jitter attenuator will receive a clock input from a master clock circuit 316 to clock out of FIFO 318 reclocked data. This will result in the output of both a “clean clock” and reclocked data to a pulse shaping and transmitter control block 320. This provides an analog pulse to a drive circuit 322, the output of which provides the output drive signal that drives pulses through the associated 1:1 transformer. The signals are provide on Tip and Ring lines 324.

The receive data on the analog side is received from a transmission line which is transformer coupled with a 1:1 transformer to receive tip and receive ring signals on two lines 328 which are input to a high input impedance variable gain receive amplifier 330. The output of the receive amplifier 330 is input to the input of an analog-to-digital converter (ADC) 332 that converts the analog signal to the digital domain which then allows processing of the digital information in the digital domain with a pulse conditioning block 334, which basically performs clock recovery, equalization and data recovery. This provides a recovered clock signal and recovered data which is then input to a decoder block 336. This decoder block 336 has the mode thereof defined by the Format input on line 308. As noted herein above, this configures the device for NRZ output or output of RPOS and RNEG data. The output of the decoder block 336 is input to a FIFO/jitter attenuator combination block 338 which is operable to utilize the output of the master clock circuit 316 to generate a clean clock and reclocked data. This data is output on two data outputs, a receive negative data output on a line 340 and a receive positive output on a line 342. The recovered and clean clock is output on an RCLK output 344.

The receive section has a loss of signal (LOS) detect block 346 that is operable to monitor the output of the pulse conditioning module block 334. When a predetermined number of zeros are received in a consecutive manner, this will generate an LOS signal detect which is then input to the decoder 336.

As noted herein above, the reference clock signal REFCLK is received on a line 136. This is then input to a master clock circuit 316, which master clock circuit 316 is common for each of the channels. This master clock circuit 316 provides a signal to the pulse conditioning block 334 and also the block 322 and a reference clock on a line 352 which is utilized by the jitter attenuator blocks 312 and 338. This reference clock input on line 136 is used as a time base for the entire LIU integrated circuit. The permissible frequencies for REFCLK, in the present disclosure, are 16.384 MHz, 19.44 MHz, 34.368 MHz, 44.736 MHz, 51.84 MHz, 77.76 MHz, and 155.52 MHz. The REFCLK frequency is indicated by the state of three input pins 354 to the integrated circuit 102, labeled CLK0, CLK1 and CLK2. Additionally, these pins can be set internally with a register. They are input to a clock control block 356. These bits CLK0/CLK1/CLK2 are set in accordance with the following Table 1 when in the reference clock mode referred herein below as refMode.

TABLE 1

| CLK2 | CLK1 | CLK0 | REFCLK |
|---|---|---|---|
| 0 | 0 | 0 | 155.52 MHz |
| 0 | 0 | 1 | 77.76 MHz |
| 0 | 1 | 0 | 51.84 MHz |
| 0 | 1 | 1 | 44.736 MHz |
| 1 | 0 | 0 | 34.368 MHz |
| 1 | 0 | 1 | 19.44 MHz |
| 1 | 1 | 0 | 16.384 MHz |
| 1 | 1 | 1 | reserved |

Additionally, the master clock circuit 316 is operable to provide a free running clock output on a line 358. This output frequency is determined by the state of two output pins 360, COF0 and COF1. The settings of those pins provide the following output frequencies as set forth in Table 2 as follows:

TABLE 2

| COF1 | COF0 | CLKOUT |
|---|---|---|
| 0 | 0 | 34.368 MHz |
| 0 | 1 | 44.736 MHz |
| 1 | 0 | 51.84 MHz |
| 1 | 1 | high impedance |

Look back operation is provided by a number of functional blocks in each of the channels. Signals from the transmit data inputs on lines 302, 304 and 306 are looped back with a local loopback block 364 to the input of the jitter attenuator block/FIFO block 338 at the same time it is transmitted to the transmit tip and transmit ring outputs on lines 324. However, there can be a mode wherein the pattern generation block 312 transmits only an Alarm Indication Signal (AIS). This loopback operation is controlled by a loopback signal on a line 366. Additionally, a remote loopback operation can be facilitated with a function block 368 that is operable to loop the receive clock and data recovered by the receiver back through the transmitter on the input of the encoder block 310 and transmit the information to the line from the transmit tip and transmit ring lines 324. The recovered data and recovered clock continue to be output on lines 340-344.

The data rate of each channel is set by two pins 370 that set the data rate to an E3 transmission rate, a T3 transmission rate or an STS-1 transmission rate, the data rate set by the bits RATE0/RATE1 in the “phyMode.” It should be understood that the term “channel” as used herein refers to a complete transceiver. However, each transmitter and receiver can be separated and considered a separate channel and not have the data rates “locked” to the same data rate, such that each would have an independent setting for RATE0/RATE1. The values for RATE0/RATE1 are set as follows in Table 3:

TABLE 3

| RATE1 | RATE0 | DATA RATE |
|---|---|---|
| 0 | 0 | E3 operation |
| 0 | 1 | T3 operation |
| 1 | 0 | STS-1 operation |
| 1 | 1 | channel power down |

It is noted that both the transmitter and receiver can operate at independent rates, such that each transmitter path and each receiver path constitute a separate data rate and have the operation thereof made selectable.

A processor interface block 374 provides an interface between each of the channels and the controller at the central core thereof. Data is provided on a data line which comprises an 8-bit parallel data port. This is a bidirectional parallel databus interface. There is provided an interrupt which, when set, pulls the interrupt line low indicating that one of the unmasked status bits (described herein below) has changed or that an error counter has overflowed. An address bus is provided that operates in conjunction with the databus, this being an 8-bit address bus wherein the lower five bits address internal registers and the upper three bits are used to select a chip address, these being the chip addressed by the upper three bits determined by a signal on three pins 376.

The LIU is operable to operate in a synchronous mode, and an asynchronous mode. A write/read control pin receives a signal when in synchronous mode that allows a parallel read mode when the pin is high and a write mode when the pin is low. In another mode, an asynchronous mode, the parallel port can be read when this pin is high and written when the pin is low. A strobe signal, STRB-Bar, is provided to allow latching of the address and/or write data, depending upon whether it is in synchronous mode or asynchronous mode and what type of synchronous or asynchronous mode is associated therewith. There is also provided a serial data input 380 which provides for a serial data input, a serial data output and a serial clock input. This allows writing and reading to various internal registers.

A serial data interface block 384 is provided which is referred to as a JTAG block which is utilized for a test data serial input mode. In this mode, serial test pattern data can be scanned into the device or driven out of the device in accordance with a serial JTAG TCK. This is a conventional data interface.

The LW can be configured utilizing either the external pins for the various modes, such as the clock frequency, or it can utilize internal registers. In a hardware mode, which can be selected, through the configuration of the mode pins MODE0, MODE1 and MODE2, dedicated pins can be used to control the overall operation. When a processor interface mode is selected, the device may be configured to interface to a variety of parallel port devices, including a synchronous and asynchronous operation or can be configured for serial interface format. Setting the channels for E3, T3 or STS-1 operation is accomplished via the dedicated pins in the hardware mode or by register settings in a host mode. Each channel must be individually configured for the operation desired. As noted herein above, the line rate for each channel is selected by setting the line rate pins 354 in the hardware mode or sending internal register bits in the host mode. The line rate settings also establish additional functional parameters required by the channel. When the internally generated timing reference, defined by the rate pins 354 (in the hardware mode), is set to a frequency that is different than the REFCLK signal on line 136, the output frequency on line 358, and the internally generated timing references for the transmitter and receiver for each channel, will be generated with varying degrees of accuracy relative to the accuracy of the REFCLK signal.

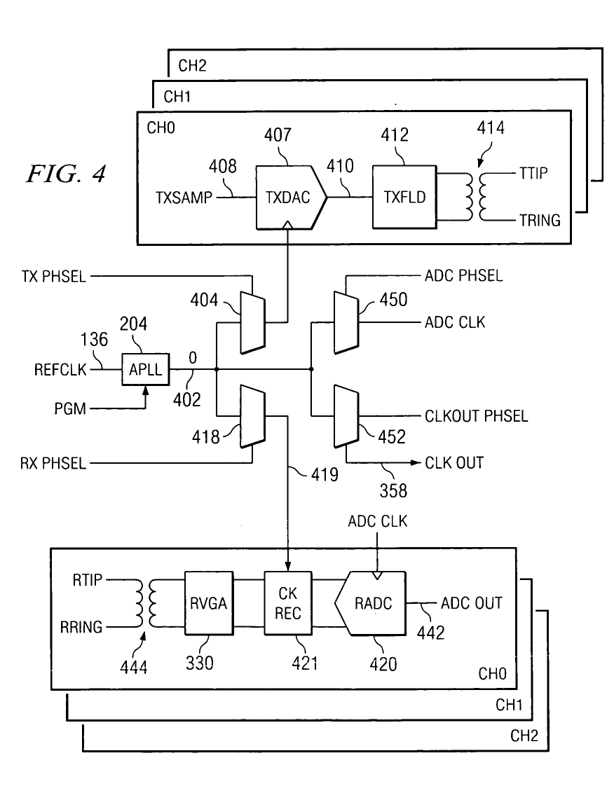

Referring now to FIG. 4, there is illustrated a more detailed diagram of the overall clock management system. As noted herein above, the analog phase lock loop (APLL) 204 is operable to be locked to one of a plurality of frequencies on the input REFCLK line 136. However, the output of the APLL 204 is maintained within a predetermined range. To facilitate this, a program signal is received at the APLL 204 that is operable to determine the REFCLK input, as defined on the input pin 354. As such, the output of the APLL 204 is restricted to a range between 400 MHz to 440 MHz. Therefore, the APLL 204 need only have a multiplier of a factor of 8/3×, 16/3×, 8×, 9×, 12×, 21× and 25× in order to receive a REFCLK at one of the transmission rates for the T3, E3 or STS-1 ranges and provide an output frequency in a fairly narrow range of around 400 MHz. By providing this program “divide” ratio to the APLL 204, the divide ratio in the feedback associated therewith can be set such that the output range is fairly narrow.

The APLL 204 is an analog circuit and provides a clock in the range of between 400 MHz to 440 MHz with selectable phases on the output. These phases are output on a bus 402 and they are selectable by various phase select multiplexers. There is provided a transmit phase select multiplexer 404 for use with one of the channels of the transmit path associated therewith. In this embodiment, there are illustrated three channels CH0, CH1 and CH2, although there could be more channels, these channels illustrated for both the receive and the transmit path. The phase select signal for the multiplexer 404 is a signal TXTHSEL that is operable to select one of the phases on the bus 402 which is input to a transmit data converter block 407 for use in converting received information on a line 408 in the digital domain, converting that to analog information in the analog domain on an output line 410 for input to a transmit filter 412, all at the data rate associated with the received data. This will provide pulse shaping for the analog signal for output to an isolation transformer 414 to provide the TTIP and TRING signals.

On the receive side, there are provided three receive paths for CH0, CH1 and CH2. Each receive path is operable to receive the RTIP and RRING signals on an input through an isolation transformer 444. This is input to the variable gain receive amplifier 330 to provide an output to a clock recovery and conditioning block 421 that is operable to provide clock recovery, jitter attenuation, etc, this then providing an output to the receive analog-to-digital conversion device, illustrated by block 420. This provides a digital output on a line 442. The clock reference for the block 421 is the jitter free version of the recovered receive. This recovered receive clock is generated with a phase select multiplexer 418 that is operable to select one of the phases of the APLL 204 in response to a phase select signal, RXPHSEL. This provides a clock output on a line 419 (for input to the block 421). The RXPHSEL signal and the TXPHSEL signal are both generated in conjunction with the operation of the jitter/attenuator, as will be described herein below.

In addition to utilizing the multiplexer 404 and 418 (it being noted that there are corresponding phase select multiplexers in each of the channels for each of the receive and transmit paths), the output of the APLL 204 is utilized to generate a common ADC clock for the purpose of providing a sampling clock to each of the ADCs on the chip, this input to the RADC 420. This is provided with a phase select multiplexer 450 that has the operation thereof controlled by an ADCPHSEL control signal. Similarly, there is also provided a free running clock output for providing a CLKOUT signal on the line 358 that is facilitated with a phase select multiplexer 452. This is controlled by a CLKOUTPHSEL phase select signal. As such, regardless of the frequency of REFCLK on line 136, the output thereof can provide the CLKOUT clock on line 358, which can be different than the REFCLK signal. By contrast, the ADC clock will be proportioned to the REFCLK frequency such that the sampling rate is known for the operation of the ADCs on the chip.

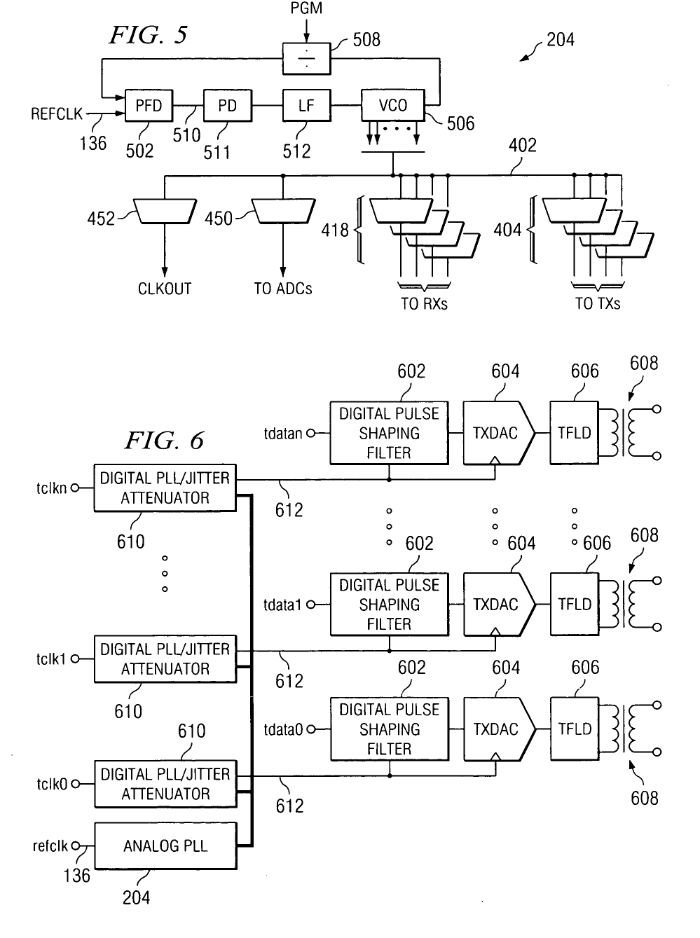

Referring now to FIG. 5, there is illustrated a diagrammatic view of the APLL 204. The APLL 204 is an analog phase lock loop that receives the REFCLK signal on line 136 that is input to a phase and frequency detector (PFD) 502. A voltage controlled oscillator 506 provides a reference frequency that is divided by programmable divider 508 for input to the other input of the PFD 502. A phase error is determined between the two signals and this phase error is output on a phase error line 510 to a pre-divider 511 that is operable to allow for fractional multiplication factors for the 77.76 MHz and 155.52 MHz reference clocks. This is filtered by a loop filter 512 to generate the control signal for the VCO 506. This is a conventional phase lock loop with the frequency thereof controlled to be approximately 400 MHz. The multiplication factor is determined by the programmable divider 508 to provide, for predefined REFCLK frequency values, a fairly restrictive range of frequencies between approximately 404 MHz to 420 MHz.

The VCO 506 provides nine output phase steps to provide a minimum phase resolution of approximately 270 pS. This utilizes a nine stage oscillator to provide this amount of resolution. These phase outputs are provided on the phase output bus 402 for input to the phase multiplexers 404 and 418 for the transmit and receive paths and to the multiplexers 450 and 452 for the ADCs and the CLKOUT outputs. The various phase select operations are controlled to “jump” between phases in order to recreate the clock from these phases. In effect, the frequency output by the VCO 506 is actually changed such that the output of each of the multiplexers 404, 418, 450 and 452 will be different than the output of the VCO 506. The operation of this clock management will be described in more detail herein below. The following table illustrates the input frequencies on REFCLK (labeled FREF), the output of the multiplexer 450 for the ADCs, the VCO 506 frequency, the multiplier factor, and the phase resolution in picoseconds.

TABLE 4

| FREF | F(ADC) | F(VCO) | PLL | Phase |
|---|---|---|---|---|
| (MHz) | (MHz) | (MHz) | MULT | Res (ps) |
| 16.384 | 204.8 | 409.6 | 25 | 271 |
| 19.44 | 204.12 | 408.24 | 21 | 272 |
| 34.368 | 206.208 | 412.416 | 12 (24/2) | 269 |
| 44.736 | 201.312 | 402.624 | 9 (18/2) | 276 |
| 51.84 | 207.36 | 414.72 | 8 (24/3) | 268 |
| 77.76 | 207.36 | 414.72 | 16/3 | 268 |
| 155.52 | 207.36 | 414.72 | 8/3 | 268 |

Referring now to FIG. 6, there is illustrated a diagrammatic view of the overall transmitter architecture illustrating the transmitter architecture for three channels. It can be seen that there are provided channels zero through n, each receiving transmit data, tdata0, tdata1, . . . , tdatan and also receiving clock signals TCLK0, TCLK1, . . . , TCLKn. For each of the channels, the data is processed with a digital shaping filter 602 and then input to a transmit DAC 604 for output to an output filter 606 to provide the output signal through an isolation transformer 608. Both the digital pulse shaping filter 602 and the DAC 604 require the clock information derived from the input transmit clock operating at the path data rate. As noted herein above, this input clock can have a jitter associated therewith due to the type of clock. For some transmission rates, the clock is a “gapped” clock. Therefore, it is desirable to provide a clean clock for the digital processing. This is facilitated with a digital PLL/jitter attenuator 610 which is operable to receive the clock input and remove the jitter therefrom and provide a clean clock on a line 612 in addition to reclocked data. Each of the clock signals on the line 612 for each of the channels and each of the transmit paths can operate in accordance with a different transmission rate. However, the analog PLL 204, which provides input phase information to each of the blocks 610 has a set frequency output defined by the reference clock input on line 136 and the divide ratio associated therewith. However, each of the digital PLL/jitter attenuator blocks 610 must provide phase lock with the received transmit clock signal such that the clean clock is phase locked to the input transmitter clock. This will be described herein below.

The PLL/jitter attenuator block 610 is utilized to provide a clean output clock that has less jitter than the input. For example, the input clock could be a “gapped” clock in “DS3 drop from STS-1” applications. The STS-1 clock at 51.84 MHz is gated such that the average rate of edge is the DS3 rate (44.736 MHz). An individual gap can be as large as 48 clocks wide. The output clock in the present disclosure provides a clean over sampled DS3 clock locked to the input gapped clock. There is provided a FIFO for the purpose of reclocking the data from the input clock to the output clock. This FIFO has a predetermined depth that is termed by the largest expected jitter, sometimes referred to as “wander” at low frequencies.

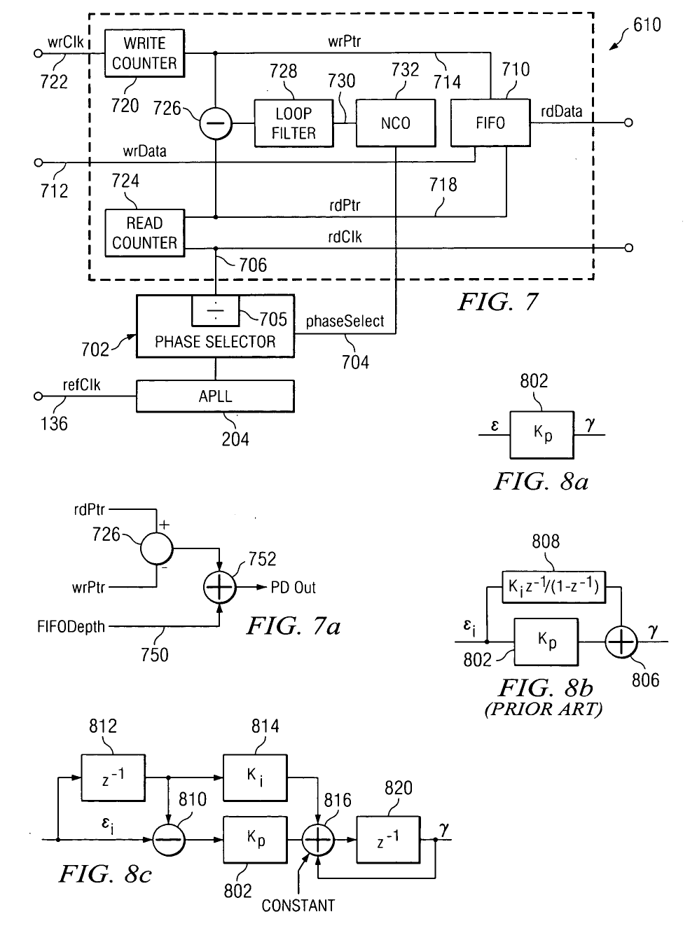

Referring to FIG. 7, there is illustrated a block diagram for the digital PLL/jitter attenuator 610 for the transmit path, although it equally applicable for the jitter attenuator for the receive path. The phase output of the APLL 204 is input to a phase selector 702 that can be controlled with a phase select signal on a line 704 to jump between the nine output phases of the APLL 204. This provides the clean clock on line 706 after passing through a programmable divider 705. A FIFO 710 is provided for receiving the write data on an input 712 and a write pointer on an input 714. Data is written into the FIFO 710 in accordance with the write pointer on line 714 and data is read out of the FIFO 710 in accordance with a read pointer on a line 718. The write pointer is derived from the output of a write counter 720 and the read pointer is derived from the output of a read counter 722. The write counter is incremented in accordance with the write clock on a line 722, which write clock is either the transmit clock or the receive clock for the associated data path. Each transition of the write clock causes the write counter 720 to increment in value. The read counter 722 is controlled by the read clock on line 706. Therefore, the read counter will read data out in synchronization with the read clock.

The output of the write counter and read counter are input to a difference circuit 726 to produce an output that is proportional to the phase difference between the input and output clocks, this being the phase detector. The output of the difference circuit 726 or phase detector is input to a loop filter 728, which loop filter provides the control aspect of the overall operation, the output thereof being a phase detect output on a line 730. This is input to a numerically controlled oscillator (NCO) 732. The NCO 732 produces on the output phase select signals, which are input to the phase select block 702. The output of the phase select block is controlled to provide a clock whose frequency is proportional to the input 730 of the NCO.

Referring now to FIG. 7a, there is illustrated a detail of the phase detector in the embodiment of FIG. 7. The read pointer and write pointer are input to the subtraction block 726 and the output thereof offset by the depth of the FIFO 710 with a value on a line 750. This is input to a summation block 752 along with the output of the subtraction circuit 726, the output of summation block 752 providing the phase detector output. Therefore, the difference between the read pointer and write pointer provides an estimate of the phase with the added FIFO depth value ensuring that the phase detector output is zero when the pointers are separated by the FIFO depth.

Referring now to FIGS. 8a, 8b and 8c, there is illustrated diagrammatic views of the loop filter 728 which provides the “controller” aspect of the system. In FIG. 8a, a proportional control is provided with a proportional gain Kₚ in a block 802. The input to the block is ε, the output thereof being γ. In FIG. 8b, the proportional control is accentuated with an integral control, which is a conventional operation and is known in the prior art. The output of the block 802 in this implementation is input to a summation block 806 with a feed forward block 808 being connected between the input of block 802 and summation block 806 in processing the input through a transform function of:

$$\frac{{K}_{i} {z}^{- 1}}{( 1 - {z}^{- 1} )}$$

The output of the summation block 806 provides the output ε. The modified proportional plus integral control is illustrated in FIG. 8c wherein the input εᵢ is input to a subtraction circuit 810, the other input thereof received by processing the input εᵢ through a delay block 812 with a transform function z⁻¹, this providing a differentiator for input to the proportional block 802. The output of block 812 is also input to a gain block 814 with a gain Kᵢ. The output of block 814 and the output of block 802 are input to summation block 816, the input of block 802 being the output of subtraction block 810. The output of summation block 816 is input to a delay block 820 with a transform function z⁻¹, the output providing the E output and this also fed back to another input of summation block 816, such that summation block 816 sums the output of block 820, the output of block 814 and the output of block 802.

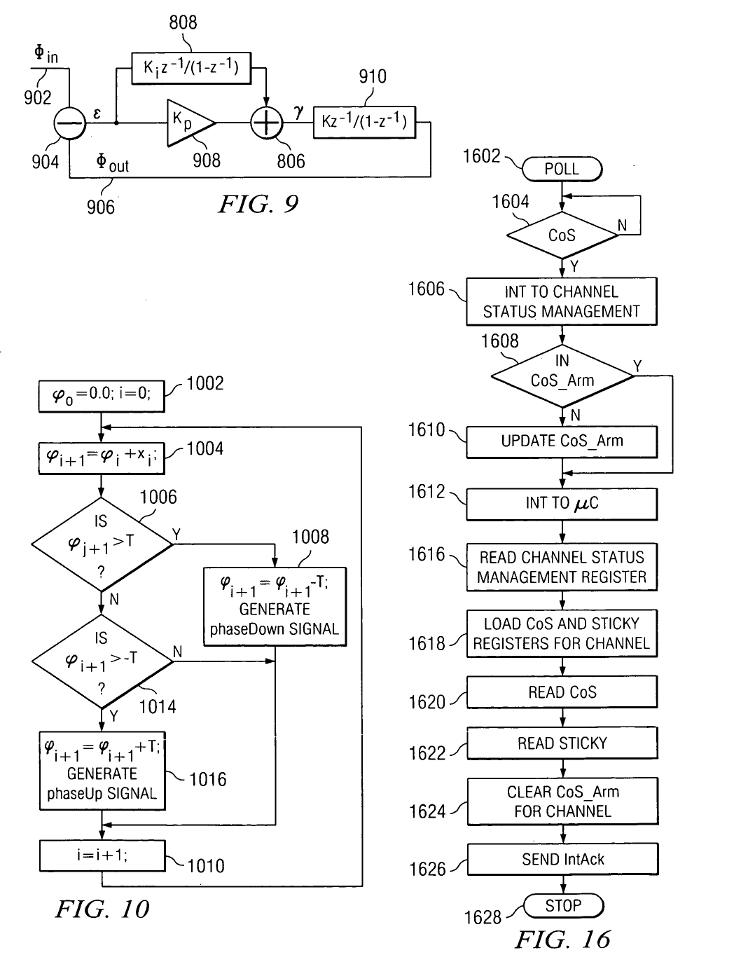

Referring now to FIG. 9, there is illustrated a diagrammatic view of a linear model of the loop. The phase input is received on the line 902 and input to one input of a subtraction block 904. The other input thereof is the phase output on a line 906. The output of subtraction block 902 provides the value of ε which is input to a block 908 having to gain Kₚ. The value of E is fed forward through the transform block 808 to the summation block 806 with the value of E being output thereof and this process through a transform block 910 with the transform function:

$$\frac{{Kz}^{- 1}}{( 1 - {z}^{- 1} )}$$

where: the phase detector gain K_{pd} is derived since it is modeled as a subtracter and the NCO is modeled as a discrete-time integrator with a gain K_{vco}. These two gains are collapsed into a single gain K wherein the values of K are 1/72(STS-1), 1/81(DS3), 1/108(E3).

The embodiment of FIG. 8b, as set forth herein above, provides the ability to utilize proportional control and integral control with the use of the proportional control block 802 and the integral control block 808. These are both added together. The embodiment of FIG. 8c, the modified embodiment, provides a differentiater block in the form of the block 812 and the subtraction block 810 which provides on the output thereof the transform (1−z⁻¹) that is input to the proportional block 802. This addresses the transient response on the input. This is followed by the proportional block 802 and then followed by an integrator. Therefore, it is the differentiater followed by the proportional block that allows the controller to achieve both frequency lock and phase lock. Although the embodiment of FIG. 8b will achieve phase lock if the frequency is relatively close, “the frequency pull” of the embodiment of FIG. 8b is inadequate to achieve lock over a large frequency range. The embodiment of FIG. 8c, on the other hand, has a narrow band response and achieves both frequency lock and phase lock. The embodiment of FIG. 8b would require a separate frequency lock functional block.

In order to operate within the narrow bandwidth of the embodiment of FIG. 8c, the modified control loop, the loop filter is adjusted with a constant that is input to the summation block 816. This constant is a function of the predetermined data transmission rate that is associated with a particular channel. This constant basically initiates the operation of the loop filter closer to the frequency of interest.

Referring now to FIG. 10, there is illustrated a flow chart for the operation of the NCO 732. The program is initiated at a block 1002 wherein the phase variable φᵢ is initialized at a value of 0.0 at the initial time of I=0. The program then flows to the function block 1004 in order to increase the value of φᵢ by the value of xᵢ, the output of the filter. This will result in φᵢ₊₁=φᵢ+xᵢ. This is the accumulator operation. The program then flows to a decision block 1006 in order to determine if the value of φᵢ₊₁ is greater than the threshold voltage T. If so, the program then flows along the “Y” path to a function block 1008 in order to generate a phase down signal and then, at the same time, increment the current phase value by the value of “T.” The program then flows to a function block 1010 to increment the value of I and then returns to function block 1004 to again accumulate the stored value by the value output by the filter.

If, at decision block 1006, it were determined that the current phase value in the accumulator were not greater than T, then the program would flow to a decision block 1014 to determine if the value of the accumulated phase was less than the value “−T,” at which time the program would flow along the “Y” path to function block 1016 to generate the phase up signal and increment the accumulated phase value by a value of “+T.” The program will then flow to the function block 1010.

The flow chart illustrates that the generated phase up and phase down signals are generated whenever the phase falls out of the window between −T through T. If the phase value is disposed there between, the program would flow from decision block 1014 to function block 1010. However, although not illustrated, the phase up signal and the phase down signal are adjusted so that the incrementing phase is a value of T in either direction. There is also a decision made, although not shown, if the value is above +2T or below −2T, at which time there will be two phase jumps in either direction.

Referring now to FIG. 1, there is illustrated a block diagram of the NCO implementation. The output of the loop filter 728 is received on input 1102. This is input to a summation block 1104. The summation block 1104 receives a frequency offset from a block 1106. This frequency offset is a combination of two values, a reference mode value on a line 1108 and a current data transmission mode on a line 1110. The value on the line 1110 is set in the phyMode where the value of the bits RATE0/RATE1 are defined. The reference mode value on input 1108 provides an offset value that corresponds to the nominal value of the VCO 506 and the required offset therefor to start the NCO as close as possible to the operating frequency, which can vary as a function of the frequency of REFCLK on line 136. Thereafter, another frequency offset is added on the input 1110 depending upon which of the transmission data rates is associated with a particular channel. These are all input to the summation block 1104 as an offset to the loop filter output. The output of summation block 1104 is input to a summation block 1112, which is operable to sum the current offset value with a current accumulated phase value in a register 1114. The output of the summation block 1112 is input to the data input of the register 1114 through a saturate block 1116 and is clocked through to the output thereof with the transmit or read clock on the clock input thereof. As such, for each edge of the transmitter read clock, another accumulate cycle will occur.

The output of summation block 1112 is also input to a phase adjust block 1118 which is operable to determine if the current accumulated value output by the summation block 1112 is greater than +T or less than −T. If greater than “+T,” then the value of “−T” is output on a line 1120 and, if less than “−T,” then the value of “+T” is output on a line 1120. Otherwise, the value of “0” is output on line 1120. As described herein above, although not shown, the phase adjust block 1118 will also determine if the value is greater than “+2T” or less than “−2T.” These values will also be output in that condition. A phase jump block 1124 is operable to determine the jumps that will be taken. The jump will either be an up or down jump and the level of that jump will be a function of the phase adjust block 1118 determination that the phase was greater than or less than the various thresholds, as set forth in flow chart blocks 1008 and 1016. The PLL up/down values are determined by a signal generator 1126, which is clocked by the output of the phase select block 702 to clock at the APLL rate. This is input to the phase selector 702 to select one of the nine phases. These phase jumps are done at the rate of the VCO clock. This is then input to a divider block 1128 which is divided by the value 8×, 9× or 12× to provide the read clock which is the output clock for the jitter/attenuator.

It can be seen that the read clock is first frequency adjusted to be within the range of the received clock and then phase locked to the received clock, that received clock being either the Rx clock or the Tx clock. Thereafter, phase adjustments are made based upon a selection of select phases of the VCO clock 506, such that each edge of the read clock basically as a stability reference to the VCO 506. Therefore, the VCO 506 provides a stable clock at a nominal frequency to provide a reference in which to initiate a phase lock.

Referring now to FIG. 12, there is illustrated a block diagram for generating the CLKOUT signal. As described herein above, the CLKOUT output can provide a clock frequency at one of a plurality of rates, those being the transmission rates of T3, E3 and STS-1, for example. These clock signals are generated from the VCO 506 of the APLL 204. In general, the generation of this clock signal is substantially identical to generation of the read pointer for the jitter/attenuator, this read pointer, as described herein above, constituting the cleaned up transmit clock or receive clock.

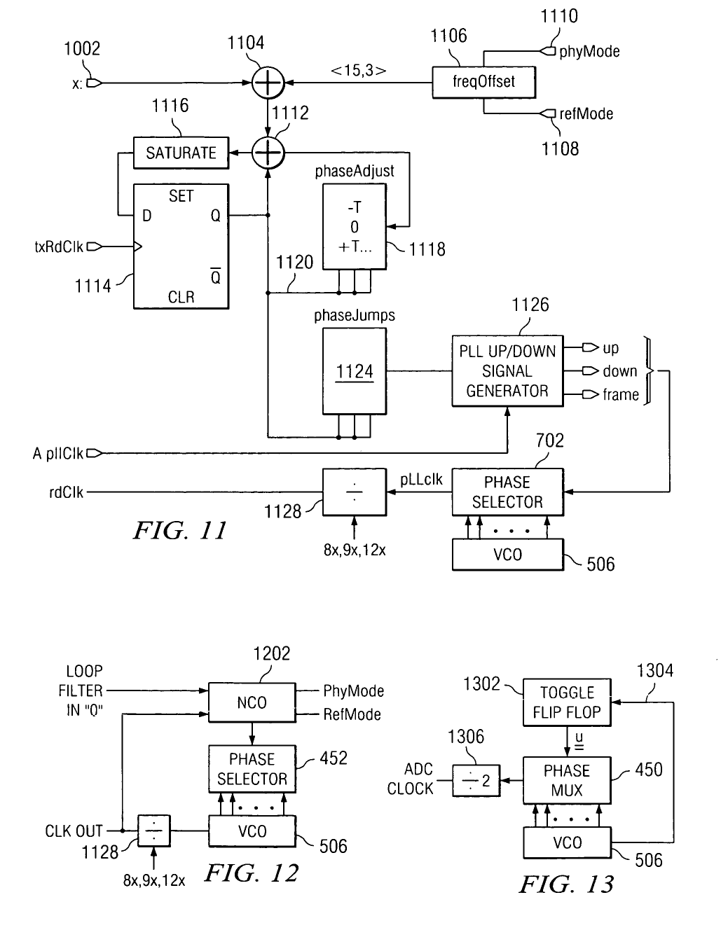

The primary difference in the circuitry of FIG. 12 is that all that is required is a numerically controlled oscillator (NCO) 1202 that is substantially identical to the NCO 732. However, the loop filter input of the NCO 1202 is set equal to a value of “0.” In operation, with reference to the flow chart of FIG. 10, the accumulator value for xi is basically a value of zero, since there is no loop filter input. The NCO 1202 operates as described herein above with reference to FIG. 11 in that for each cycle of CLKOUT, the register 1114 is updated with the accumulator value and is utilized to perform the phase adjust and the block 1124 operated to perform the various phase jumps. As such, regardless of the REFCLK frequency, the CLKOUT frequency can be set independent thereof. This, of course, is conditioned upon the fact that the value of REFCLK is known in order to set the various frequency offsets in the REFMODE and the desired CLKOUT signal is determined by the value set during PHYMODE of the bits COF0/COF1. Thus, knowing the offset allows the NCO 1202 to acquire a lock faster and, after generation of the output phases from the phase selector and processing through the divide block 1128 that selects the factor to divide by, this factor based upon the factor utilized to generate the VCO frequency in VCO 506. With this information, a “free running” clock can be provided that is not locked to any input clock frequency.

Referring now to FIG. 13, there is illustrated a block diagram of the structure required to generate the over sampled ADC clock. The ADC clock is required to be slightly faster than the lowest frequency of the VCO 506. To facilitate this, the phase multiplexer 450 is jumped by an increment of one phase value of nine available phase values for every other cycle of the VCO 506. A Toggle Flip Flop 1302 is provided that is clocked by the output of the VCO 506 on an output line 1304, this being one of the phase outputs thereof, such that an up-command is output to the phase multiplexer 450 for every other cycle of the VCO 506. This is basically a two bit counter. The output of the phase multiplexer 450 is then input to a divide-by-two divider 1306 to provide the ADC clock. This ADC clock is the clock utilized by all of the ADCs in all of the receive channels on the LIU.

### Channel Status Management System

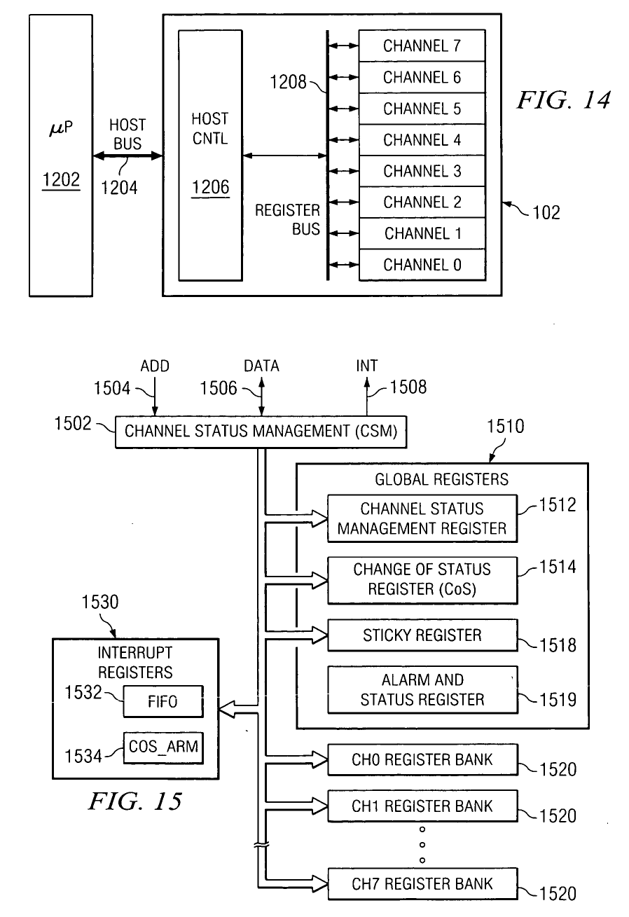

Referring now to FIG. 14, there is illustrated a diagrammatic view of the LIU 102 illustrating its interface with an external host microcontroller 1202. The host microcontroller 1202 is operable to interface with the LIU 102 through a host bus 1204. The host bus 1204 can be a parallel or serial bus, depending upon the type of microprocessor that is utilized in the host microcontroller 1202. There are multiple different microprocessors and communication configurations that are required. The LIU 102 will handle these different configurations through a host controller 1206 that is internal to the LIU 102. The host controller 1206 is operable to interface between the host bus 1204 and a register bus 1208 that is operable to interface with the registers on each of the channels, there being illustrated eight potential channels. As described herein above, a channel is defined as a transceiver that has both a transmit and a receive path, as illustrated in FIG. 3 herein above. Additionally, as will be described herein below, there are a plurality of different registers associated with the operation of each of the channels and the interface thereof to the host microcontroller 1202. There are global registers and there are channel specific registers. The global registers are registers that can be accessed by the external host microcontroller 1202 and the host controller 1206 and are addressable by the host microcontroller 1202. The channel specific registers are holding registers that are read by the host controller 1206 and stored in the internal global registers which are part of the host controller, such that the information can then be provided to the host microcontroller 1202 via the global registers.

In order to access the information in the various registers that store status information and alarm information, a Channel Status Management System (CSM) is contained within the host controller 1206. The CSM allows the external microcontroller to either read the global registers in response to the generation of an interrupt or to poll the global registers in order to manage changes in the various alarm and status bits that are generated for each channel. As described herein above, each channel has an alarm and status register which indicates the current status for that channel. If there is a change of an enabled status bit associated with a particular parameter, the channel status management system identifies which channel has had a change of status, indicates which bit changed state, and provides a “sticky” version of the alarm and status register so intermittent status changes can be captured. A sticky bit is defined as a bit that, once set, will be reset once read.

Any bit in the alarm and status registers, for which channel status management is desired, must be enabled by setting the corresponding bit in each channel's channel status management enable register to a “1.” If interrupts are desired, they must be enabled by setting an enable bit in the control register for that particular status bit and channel to a “1,” noting that each channel has a control register.

Whenever an enable alarm or status bit for a particular monitored parameter or alarm changes state, the corresponding channel number will be queued, and the active change of status bit will be set to a “1” in one of the global registers referred to as a CSM register. If interrupts are enabled for that particular parameter, an interrupt will be issued. Upon reading the contents of the CSM register, the offending channel will be indicated through information stored therein and then two other global registers will be accessed. The first is referred to as a Change of State (CoS) register that contains information specific to the offending channel as to which of the monitored parameters or alarms has undergone a change of state (created an alarm). The other register is also specific to the offending channel and contains information as to what the change is. Therefore, the host microcontroller 1202 need only access three registers in order to determine that there is a status change and what that is, independent of the number of channels that are associated with the LIU 102. The sticky register, as will be described in more detail herein below, will provide a sticky version of the channel's alarm and status information, which is stored in a channel specific alarm and status register, one such register for each channel. Finally, there is provided a CSM current status register will provide the offending channel's status and allow for the determination of whether the condition is persistent or intermittent. If there are additional channels that have alarms, the channel numbers will be provided on subsequent reads of the CSM register. If there are no additional channels in the queue, the active of change of status bit will be set to “0” in the CSM register.

The change of status, sticky and current registers will only provide information for the channel last indicated in the CSM register. If there is more than one bit change for a channel in the queue, the changes for that channel will accumulate until the channel pops off the queue and is provided in the CSM register. Once a sticky bit is set or cleared, it will remain set or cleared until the sticky register is read. If a channel that is currently being serviced has a new alarm, it will go to the end of the queue.

Interrupts can also be used to read indications of errors. Although not described, there is provided in the system a test mode that will indicate an error in an error count register. When the error count register fills to all ones, the channel will be indicated in the CSM register and an appropriate bit will be set. Both the active change of status and the error count flag in the CSM register may be set simultaneously indicating error count register being full as well as a change of state for the indicated channel.

An active interrupt will be cleared when the CSM register has been read. If there are additional channels in the queue, a subsequent interrupt will be indicated almost immediately. If desired, interrupts can be disabled until all channels in the queue have been serviced.

Polling may be used if interrupts are undesired. A polling routine need only read the CSM register, monitoring the status of the active change of status and error count flag bits. When utilizing interrupts or polling, only enabled status bits are tracked by the channel status management system. A change of state or any enabled alarm status bit will cause the channel number to be queued and the active change of status bit to be set to a “1.”

Referring now to FIG. 15, there is illustrated a diagrammatic view of the various register configurations. A channel status management block (CSM) 1502 is provided that is operable to interface between the address data and interrupt lines to the host microcontroller 1202 over the host bus 1204. Address information on an address bus 1504 will be provided, a data output on a bus 1506 and interrupt output on a bus 1508 will be provided, with control inputs also provided (not shown). The CSM block 1502 interfaces with global registers 1510 that, as described herein above, provide access by the host microcontroller 1202 to status information regarding the operation of the channels. The global registers consist of a CSM register 1512, a change of state register (CoS) register 1514, a sticky register 1518 and an alarm and status register 1519. The operation of these four registers 1512-1519 will be described herein below. Each of the channels has associated therewith a register bank for containing change of state information, these indicated by register banks 1520 for each channel. The register banks in the channels are accessible by the CSM block 1502. The global registers 1510 are accessible by the host microcontroller 1202 and are directly addressable thereby. Therefore, they can be polled.

The global registers 1510 are illustrated as only including the four global registers. However, it should be understood that the global register bank could also includes other global registers. Although not shown, the other global registers provided include a channel pointer register that is used during configuration of a register and has bits that will point to a particular channel for the purpose of reconfiguration thereof. There is provided a control register that contains some read only bits and some read/write bits. The control register includes a reset bit to provide a software reset of all internal circuitry, including registers which are set to their default state. It also includes a monitor bit is associated with the receive monitor mode which can be set to put all receivers into the monitor mode, wherein the receiver is set for full sensitivity and will then recover signals at the DSX-3 monitor ports. An enable interrupt bit is provided that allows interrupts to be globally enabled or disabled. A transmitter high impedance bit is operable to set the transmitter output to a high impedance state. A transmitter power down bit is operable to set the transmitter to its lowest power condition and the output impedance thereof to a high impedance state. A receiver power down bit sets all the receivers into a low power state.

A clock control register is provided in the global register space that contains the bits COF-1, COF-0 and CLK2, CLK1 and CLK0. The operation of these was described hereinabove.

With respect to the global registers that are associated with the CSM operation, the CSM register 1512 is the first register that is examined by the host microcontroller 1202 in order to determine if there is an alarm or status change condition. As noted hereinabove, there are two reasons that the host microcontroller 1202 will examine this register 1512. The first is in response to an interrupt and the second is during a polling operation. This register 1512 contains information associated with inactive/active change of state operation, an error control flag and the channel that generated the active change of state condition or the error control condition. The CSM register 1512 is set forth in Table 5 as follows:

TABLE 5

| | Register 3 (03 h) -- CSM - Channel Status Management Register | | | | | | |
|---|---|---|---|---|---|---|---|
| Bit | Name | Access | States | | | | Reset Value |
| 7 | A_CoS | R | Active Change of State CoS and | | | | 0 |
| | | | Sticky | | | | |
| | | | 0 = No Change of State | | | | |
| | | | 1 = Change of State available in | | | | |
| | | | CoS/Stky registers | | | | |
| 6 | ErrCntF | R | Error Count Register Full | | | | 0 |
| | | | 0 = Error Count Register is not full | | | | |
| | | | 1 = Error Count Register has filled | | | | |
| | | | to FFFF | | | | |
| 5, 4, 3 | rsvd | R | Reserved | | | | 0, 0, 0 |
| 2, 1, 0 | CH2, CH1, CH0 | R | CH2 | CH1 | CH0 | CHANNEL | 0, 0, 0 |
| | | | 0 | 0 | 0 | channel 0 | |
| | | | 0 | 0 | 1 | channel 1 | |
| | | | 0 | 1 | 0 | channel 2 | |
| | | | 0 | 1 | 1 | channel 3 | |
| | | | 1 | 0 | 0 | channel 4 | |
| | | | 1 | 0 | 1 | channel 5 | |
| | | | 1 | 1 | 0 | channel 6 | |
| | | | 1 | 1 | 1 | channel 7 | |

As can be seen in the register location set forth in Table 5, bit 7 is the active change of state bit, A_CoS, that, when set to a “1” provides an indication that there has been a change of state for the indicated channel's alarm and status bit. This bit will only respond to those alarm and status bits that have been enabled during configuration. The bits that have changed state are indicated in the change of state (CoS) register 1514. This is a “sticky” bit and will clear once it has been read.

Bit 6 of the CSM register 1512 is the error count register full flag, ErrCntF. Although not described herein, test circuitry provided on the LIU 102 will be set to a “1” when an error count register (not shown) for the indicated channel, fills to all ones, FFFF. This bit is a sticky bit and will clear once it has been read or when the error count registers have been written to.

Bits 0, 1 and 2 are the channel indication bits CH0, CH1 and CH2. The values stored for these bits indicate the particular channel that is associated with either the error control flag or the active change of state bit. As such, by examining a single register and the eight-bit word associated therewith, the host microcontroller 1202 can determine first if there is a change of state or an error condition and then, if so, it can determine which channel it is associated with. As will be described herein below, if there are concurrent, multiple channels that have status changes, they are queued in the operation of the CSM 1502 and will be indicated in the order in which they occurred by subsequent reads of the register 1512. For status bit changes, reading of CSM register 1512 will clear the interrupt (if enabled), and then load the CoS register 1514 and sticky register 1518. It is noted that each channel has a mirror of the CoS register 1514 and the sticky register 1518 (noting that this mirroring operation is actually an address mapping operation to a corresponding channel specific register). By reading register 1512, that mirrored register from the channel associated with the change of state or error condition will then be loaded. Once loaded, the CoS register 1514 will indicate which channel status bits have changed, for the indicated channel, and sticky register 1518 will provide a sticky version of the particular channel's status register. The alarm and status register 1519 provides the current status of an indicated channel, as will be described herein below, and is accessible to determine the current status of a bit in order to evaluate intermittent status changes.

The change of state register 1514 is read after reading of the CSM register 1512. The information stored in register 1514 is set forth in Table 6.

TABLE 6

| | Register 4 (04h) -- CoS (Change of State) Register | | | |
|---|---|---|---|---|
| Bit | Name | Access | States | Reset Value |
| 7 | DSCc | R | Driver Short Circuit Indica- | 0 |
| | | | tion has changed | |
| 6 | DOCc | R | Driver Open Circuit Indica- | 0 |
| | | | tion has changed | |
| 5 | LOSc | R | Loss of Signal has changed | 0 |
| 4 | ALOSc | R | Analog Loss of Signal has | 0 |
| | | | changed | |
| 3 | LOLc | R | Loss of Lock has changed | 0 |
| 2 | DSQc | R | Driver Signal Quality has | 0 |
| | | | changed | |
| 1 | TxFIFOEc | R | Tx FIFO Error has changed | 0 |
| 0 | RxFIFOEc | R | Rx FIFO Error has changed | 0 |

The register 1514 contains valid information for the indicated channel when the A_CoS bit in register 1512 is set to a “1.” The CoS register us updated when the CSM register 1512 is read. CoS indicates which bits in the indicated channel's alarm and status register 1519 have changed. An Alarm and Status bit has to be enabled for a change to be reflected in the CoS register. An alarm is enabled when a “1” is written to the corresponding bit position in the channel alarm and status enable register for any channel. Although not shown, each channel has associated therewith an alarm and status enable register that allows each alarm or status condition to be enabled. An enabling of this bit will allow current values of the alarm and status information in the alarm and status register 1519 to be transferred to the CoS register 1514. The values in the alarm and status register 1519 will always indicate that particular channel's particular status.

The sticky register 1518 holds a change in state (whether high or low) of each channel's alarm and status registers 1519 such that intermittent events can be captured. The sticky register 1518 is intended to be read after the CSM register 1512, and contains valid information for the indicated channel when the A_CoS bit is set to a “1” in the CSM register 1512. The sticky register is updated when the CSM register 1512 is read. As noted herein above, an alarm and status bit in the register 1518 has to be enabled in the enabling register for a change to be reflected in the sticky register 1518. An alarm is enabled when a “1” is written to the corresponding bit position in the particular channel's alarm and status enable register. Each channel's alarm and status register 1519 will always indicate its current status. The contents of register 1518 are set forth in Table 7.

TABLE 6

| | Register 4 (04 h) - CoS (Change of State) Register | | | |
|---|---|---|---|---|
| | | | | Reset |
| Bit | Name | Access | States | Value |
| 7 | DSCc | R | Driver Short Circuit Indication has | 0 |
| | | | changed | |
| 6 | DOCc | R | Driver Open Circuit Indication has | 0 |
| | | | changed | |
| 5 | LOSc | R | Loss of Signal has changed | 0 |
| 4 | ALOSc | R | Analog Loss of Signal has changed | 0 |
| 3 | LOLc | R | Loss of Lock has changed | 0 |
| 2 | DSQc | R | Driver Signal Quality has changed | 0 |
| 1 | TxFIFOEc | R | Tx FIFO Error has changed | 0 |
| 0 | RxFIFOEc | R | Rx FIFO Error has changed | 0 |

The alarm and status register 1519 for each channel is intended to be read after reading of the CSM register 1512, and contains valid information for the indicated channel when the A_CoS bit is set to “1.” The register 1519 is equivalent to the indicated channel's alarm and status register, but contains the current status. This information will only be reflected in the sticky register 1518 if the bit is enabled for that particular alarm condition or status condition. The contents of this register are set forth in Table 8.

TABLE 7

| | Register 5 (05 h) - Alarm and Status Sticky Register | | | |
|---|---|---|---|---|
| | | | | Reset |
| Bit | Name | Access | States | Value |
| 7 | DSC_stky | R | Driver Short Circuit Indication | 0 |
| 6 | DOC_stky | R | Driver Open Circuit Indication | 0 |
| 5 | LOS_stky | R | Loss of Signal | 0 |
| 4 | ALOS_stky | R | Analog Loss of Signal | 0 |
| 3 | LOL_stky | R | Loss of Lock | 0 |
| 2 | DSQ_stky | R | Driver Signal Quality | 0 |
| 1 | TxFIFOE_stky | R | Tx FIFO Error | 0 |
| 0 | RxFIFOE_stky | R | Rx FIFO Error | 0 |

Each of the register banks 1520 contain a channel alarm and status register. The values of this register are set forth in Table 9.

TABLE 9

| | Register 24 (185 h) -- Channel n Alarm and Status | | | |
|---|---|---|---|---|
| Bit | Name | Access | States | Reset Value |
| 7, 6 | DSC, DOC | R | Driver Short Circuit, Driver Open Circuit | 0, 0 |

| | | |
|---|---|---|
| DSC | DOC | Channel Condition |
| 0 | 0 | Normal Operation |
| 0 | 1 | Driver open circuit |
| 1 | 0 | Driver short circuit |
| 1 | 1 | Driver transmitting zeros |

| | | | | |
|---|---|---|---|---|
| 5 | LOS | R | Loss of Signal | 1 |
| | | | 0 = Normal Operation | |
| | | | 1 = Receiver Loss of Signal | |
| 4 | ALOS | R | Analog Loss of Signal | 1 |
| | | | 0 = Normal Operation | |
| | | | 1 = Analog Loss of Signal has occurred | |
| 3 | LOL | R | Receiver Loss of Lock | 1 |
| | | | 0 = Normal Operation | |
| | | | 1 = Receiver is not locked | |
| 2 | DSQ | R | Degraded Signal Quality | 0 |
| | | | 0 = Normal Operation | |
| | | | 1 = Degraded Signal Quality has been detected | |
| 1 | TxFIFOE | R | Transmit FIFO Error (overflow/underflow) | 0 |
| | | | 0 = Normal Operation | |
| | | | 1 = Transmit FIFO has overflowed/ | |
| | | | underflowed | |
| 0 | RxFIFOE | R | Receive FIFO Error (overflow/underflow) | 0 |
| | | | 0 = Normal Operation | |
| | | | 1 = Receive FIFO has overflowed/underflowed | |

This channel alarm and status register 1519 contains valid information for the channel indicated in the channel pointer. The registers 1514-1519 associated with the Channel Status Management function are provided as part of the Channel Status Management system to help a user track and manage changes in the bits of this channel alarm and status register for the particular associated channel. The register 1519 will reflect the setting of the channel alarm and status register for the channel indicated in the CSM register 1512. A description of each of these bits will be set forth as follows.

The DSC status bit is set in bit 7 of this register, which provides an indication of a driver short circuit. If the internal driver monitor determines that the driver current is high, DSC will be set to “1” for the offending channel(s) indicating that off-chip impedance is low, possibly as a result of a short circuit. If enabled, an interrupt will be issued when DSC changes state. DSC indicates the current alarm condition for the channel. If low transmit current is due to transmission of consecutive zeros, DSC and DOC are both set to “1.” DSC is disabled if the transmitter is placed in high-impedance mode. The DOC indicator provides an indication of a driver open circuit. If the internal driver monitor determines that the driver current is low, DOC will be set to “1” for the offending channel(s). If enabled, an interrupt will be issued when DOC changes state. DOC indicates the current alarm condition for the channel. If low transmit current is due to transmission of consecutive zeros, DSC and DOC are both set to “1.” DOC is disabled if the transmitter is placed in high-impedance mode.

The LOS status bit relates to a loss of signal occurring when the receiver receives 175+/−5 consecutive zeros (based on the internal reference clock). Zeros will result from either no signal input to the receiver, or the input signal falling below the analog LOS threshold when ALOSSq is set to “1.” LOS represents the current alarm condition for the channel. The ALOS signal is utilized to determine if the input signal to the receiver falls below the ALOS set threshold (nominally −21.3 dBV), wherein the ALOS bit will be asserted. If the receive signal is above the ALOS clear threshold (nominally −18.7 dBV), the ALOS bit will be deasserted. If ALOSSq is set to “1,” the receiver will set recovered data to zero when ALOS is asserted. After 175 consecutive zeros, LOS will be asserted for the offending channel. If ALOSSq is “0,” recovered data will be output.

The LOL status bit indicates a loss of lock at the receiver. It is asserted when the signal level is too low or the S/N is sufficiently diminished that the receiver is unable to lock onto the input signal. When LOL remains high for 8192 symbols, receive data is squelched (set to zero), and LOS and ALOS will be asserted. LOL represents the current alarm condition for the channel.

The DSQ status bit is provided for indicating a degraded signal quality. This occurs when receive signal becomes erratic, compromising a receiver's ability to accurately recover data. If enabled, an interrupt will be issued when DSQ changes state. DSQ reflects the current alarm condition for the channel. If the alarm condition persists, DSQ will remain asserted.

The TxFIFOE status bit provides an indication of an error in the transmit FIFO (as an overflow or underflow). If this condition is imminent, this bit will be set. FIFO overflow/underflow will be indicated when the read and write pointers are separated by only one bit. If enabled, an interrupt will be issued when TxFIFOE changes state. The receive FIFO error is indicated by a status bit RxFIFOE. If an overflow or underflow condition is imminent for the receive FIFO, this bit will be set. FIFO overflow/underflow will be indicated when the read and write pointers are separated by only one bit.

Referring further to FIG. 15, the CSM 1502 interfaces with an interrupt service block 1530, which contains an interrupt servicing FIFO 1532 and a change of state ARM register 1534. The register 1534 is labeled as the CoS_ARM register. The FIFO 1532 will indicate the order in which interrupts are generated by each of the channels to the CSM 1502. When an interrupt is generated by one of the channels, its CoS register is updated, and its sticky register is updated in addition to its alarm and status register. However, if a channel generates a second interrupt before the first interrupt was serviced, there is no reason to place this channel in the FIFO, due to the fact that the “hidden” registers that are not globally viewable will merely be updated prior to being loaded into the global register space (or, more accurately, being mapped to the global register space) and, when that particular channel's interrupt is serviced, it will read all of the accumulated status changes. The register 1534 is provided such that each channel has a single bit associated therewith and the CSM 1502 will merely examine the state of that bit for the particular channel to determine if an interrupt is already posted for that particular channel prior to queuing that interrupt. Register 1534 is an eight-bit register that is only one bit wide, providing one bit for each of eight potentials channels.

The FIFO 1532 is eight bits deep and three bits wide, such that each FIFO location can store a three-bit word. There will be a Current CoS pointer and a Next CoS pointer. The new interrupt will be stored in the FIFO location pointed to by the Next CoS pointer and the Current CoS pointer which points to the ‘FIFO location that is currently being serviced will be decremented after each interrupt is serviced.

Referring now to FIG. 16, there is illustrated a flow chart for the overall CSM operation. The flow chart is initiated at a block 1602 and then proceeds to a decision block 1604. Decision block 1604 determines if there has been a CoS event in any of the channels. If this occurs in a channel, the channel will automatically update its associated alarm and status register, but will only update the associated CoS register and sticky register if the interrupt capability for that particular CoS event is enabled. If it is enabled, then an interrupt will be generated to the CSM, this being internal to the LIU 102. The program will then flow along the “Y” path to a function block 1606 where the interrupt is generated and received by the CSM and serviced. The CSM 1502 then examines the CoS_ARM register 1534 to determine if there is already an existing interrupt in the FIFO 1532 waiting to be serviced, this indicated by decision block 1608. If not, the program will flow to a function block 1610 to update the CoS_ARM register 1534 and then flows to the function block 1612 to generate an interrupt to the microprocessor, this being the current interrupt in the FIFO, and not necessarily the interrupt associated with the most recently generated interrupt to the CSM from a channel. The decision block 1608 will flow along the “Y” path to the input of the function block 1612 if it were determined that an interrupt for the particular channel generating the interrupt to the CSM.

When the interrupt is generated external to the host, the host will then read the CSM register 1512, as indicated by function block 1616. This will determine if there is a change of state and, if so, the program will flow to a function block 1618 wherein the CoS register 1514 and the sticky register 1518 will be loaded into the global register space so that it can be viewed by the host. In addition, the alarm and status register 1519 for the indicated channel in the CSM register 1512 will also be loaded. After loading the registers, the program flows to a function block 1620 to read the CoS register 1514. This provides an indication to the host as to which parameter has had a change of state. This only provides an indication as to which bits in the channel's alarm and status register have changed and not what the change is. The change is determined by reading the information from the sticky register 1518, as indicated by function block 1622. The sticky register 1518 will contain a bit for the events such that the host will now know what the change was. Therefore, examination of register 1518 indicates that there has been a change or that an event has occurred for a particular monitored parameter. Examination of the sticky register at block 1622 will indicate what that change is. After reading of the register 1518, the bit read is then reset. Although not necessary, the host does have the ability to read the alarm and status register 1519 which contains the current status of all of the events.

After the information has been read out, the program proceeds to a function block 1624 to clear the CoS_ARM register 1534 for that channel and then proceeds to function block 1626 and sends an interrupt acknowledgment signal. The program then flows to an END block 1628 to again wait for an interrupt. Therefore, it can be seen that the operation set forth in the flow chart from block 1602 to block 1610 at the input of block 1612 is internal to the CSM 1502 and is utilized to queue interrupts to be serviced by the host. Once these interrupts are queued and the appropriate registers within each channel are updated, then interrupts will be generated to the host. Thus, it can be seen that each of the channels operates independent of the other channels and the information is provided only to the host when the host examines the contents of the CSM register, which is loaded with information from the FIFO indicating which channel is requesting an interrupt due to a change of state and, thereafter, the appropriate CoS registers, sticky register and alarm and status register and information for the current channel in the queue is then loaded into the global space. In general, this loading is merely a redirection of the address by controlling one or two MSBs in the address. Of course, any addressing scheme could be utilized and, in fact, there could be a process wherein an actual transfer of data from one register to a global register could occur.

Although the preferred embodiment has been described in detail, it should be understood that various changes, substitutions and alterations can be made therein without departing from the spirit and scope of the invention as defined by the appended claims.

What is claimed is:

1. A method for managing status information in a multi-channel Line Interface Unit (LIU) embodied in an integrated circuit and having a plurality of channels and operable to generate a plurality of status signals regarding the status of various associated parameters relating to the operation of the LIU, comprising the steps of:
providing a plurality of channel registers in channel register space for each of the channels in the LIU, select ones of the registers designated for storing status information for the associated channel and wherein there can be a change of state of the status for any parameter associated with the operation of the associated channel;
upon the occurrence of a change of state (CoS) for any of the status information, providing a CoS indication therefor;
monitoring with a channel status information system (CSM) for the occurrence of a CoS indication at any of the channels;
the CSM making available to an external controller such occurrence; and
when the external controller requests information regarding such occurrence of the CoS indication, the CSM making available information about the status information that was associated with the CoS that provided the CoS indication.

2. The method of claim 1, wherein there is provided a global register space and he CSM is operable to place in a global CSM register in the global register space a CoS signal to indicate that there has been a CoS event, wherein the external controller has access to the global CSM register.

3. The method of claim 2, and further comprising the step of generating an external interrupt signal for output to the external controller in the step of the CSM making available to an external controller such occurrence, wherein the external controller is operable to access the global CSM register in response thereto.

4. The method of claim 2, and further comprising the step of storing in a change of status (CoS) register in the register space for an associated channel change of status indications for that channel in association with each parameter of the channel for which status information can be obtained, which provides an indication of which status information underwent a change of status, and wherein a change of status in any of the parameters will cause a CoS indication to be output to the CSM in conjunction with an update of the associated change of status indicator.

5. The method of claim 4, wherein the CSM is operable to provide to the external controller access to the CoS register for the one of the channels associated with the CoS indication stored in the CSM register.

6. The method of claim 5, where in the access is granted only after access to the CoS register by the external controller has been effected thereby.

7. The method of claim 5, and further comprising the step of storing in a status register in the register space for an associated channel status indications for that channel in association with each parameter of the channel providing status information for each of the parameters associated therewith.
